(19) United States
(12) Patent Application Publication
(10) Pub. No.: US 2017/0279503 A1
(43) Pub. Date: Sep. 28, 2017

(54) BASE STATION APPARATUS, TERMINAL DEVICE, AND COMMUNICATION METHOD

(71) Applicant: Sharp Kabushiki Kaisha, Sakai-City, Osaka (JP)

(72) Inventors: Hiromichi TOMEBA, Sakai City (JP); Jungo GOTO, Sakai City (JP); Osamu NAKAMURA, Sakai City (JP); Shiro WAKAHARA, Sakai City (JP); Yasuhiro HAMAGUCHI, Sakai City (JP)

(73) Assignee: Sharp Kabushiki Kaisha, Sakai City, Osaka (JP)

(21) Appl. No.: 15/506,947

(22) PCT Filed: Aug. 28, 2015
(86) PCT No.: PCT/JP2015/074422

§ 371 Date: Feb. 27, 2017

(30) Foreign Application Priority Data
Sep. 24, 2014 (JP) 2014-193247

(51) Int. Cl. H04B 7/0417; H04B 7/04; H04B 7/06

(52) U.S. Cl. CPC H04B 7/0417; H04B 7/0686; H04B 7/0482; H04B 7/0413

(57) ABSTRACT

Provided are a base station apparatus, a terminal device, and a communication method that can realize a small cell network while reducing load on the terminal device, the small cell network including a small cell performing massive MIMO transfer. The base station apparatus of the present invention is a second base station apparatus included in a communication system in which a plurality of the second base station apparatuses capable of acquiring assistance information from a first base station apparatus communicates with a terminal device, the base station apparatus including a codebook that describes a plurality of linear filters, in which the same cell identification number as at least one of the other second base station apparatuses is configured, and a synchronization signal correlated with the cell identification number is transmitted on the basis of the plurality of linear filters after first precoding of the synchronization signal.

### TECHNICAL FIELD

The present invention relates to a base station apparatus, a terminal device, and a communication method.

### BACKGROUND ART

Standardization of a long term evolution (LTE) system which is a 3.9 generation wireless communication system for portable phones is completed, and an LTE-Advanced (LTE-A; referred to as IMT-A or the like as well) system which is a further development from the LTE system is currently in standardization as one of fourth generation wireless communication systems (4G system). In addition, reviews of a fifth generation wireless communication system (5G system) are started with the aim of starting service for commercial use in 2020.

The 5G system is expected to be significantly improved from the 4G system from various viewpoints such as dealing with data traffic that is expected to be suddenly increased or improving a user-sensible throughput. A small cell network (heterogeneous network) in which a small cell having a comparatively narrow coverage area overlays a macro cell having a large coverage area is very effective in improving a system throughput or a user-sensible throughput, and a network of the 5G system is expected to be an ultra-dense network in which the density of small cells is further increased. However, performance is not limitlessly improved by densifying a network, and thus securing new frequency resources is considered to be essential for the 5G system.

Usable frequency bandwidths are limited, and particularly the usage of frequency bands (microwave bands and the like) appropriate for mobile wireless communication is in a state of significant shortage. Therefore, use of extremely high frequency bands (millimeter wave bands and the like) that are not assumed to be used in mobile wireless communication so far is under review in order to realize the 5G system. However, propagation loss (path loss) in which the intensity of a radio wave is exponentially attenuated with respect to a communication distance is increased as a communication frequency (a carrier frequency) is high. This indicates that enormous transmit power is required compared with low frequency bands.

In recent wireless communication systems starting from LTE, multiple-input multiple-output (MIMO) transfer that uses a plurality of transmit/receive antennas is practically used in order to improve the frequency efficiency. If the carrier frequency is high, the sizes or installation intervals of antennas included in a base station apparatus and a terminal device can be decreased. Thus, a large number of antennas can be installed in the base station apparatus and the terminal device without changing the area of installation.

With focus on this point, massive MIMO that realizes large capacity communication by using a large number, a few hundreds, of antennas has drawn attention recently (disclosed in NPL 1 and the like). Massive MIMO can improve signal-to-noise power ratio (SNR) by beamforming that uses a large number of antennas arranged in the base station apparatus, and thus a decrease in reception SNR that is caused by an increase in propagation loss due to a high carrier frequency can be compensated. If massive MIMO transfer is applied to a small cell, the throughput can be significantly improved.

Massive MIMO transfer is a technology based on beamforming. Thus, the base station apparatus has to perform data transfer by directing an appropriate beam to the terminal device. Therefore, a method in which the base station apparatus transmits a plurality of reference signals by using different beams and in which the terminal device notifies the base station apparatus of reception quality for each reference signal is under review. In this method, a beam used for a reference signal for which the best reception quality is observed in the terminal device is the optimal beam. Thus, the base station apparatus can realize massive MIMO transfer by using the beam.

### CITATION LIST

### Non Patent Literature

NPL 1: F. Rusek, et. al., “Scaling up MIMO: Opportunities and challenges with very large arrays,” IEEE Signal Process. Mag., Vol. 30, No. 1, pp. 40-60, January 2013.

### SUMMARY OF INVENTION

### Technical Problem

In the small cell network in which a plurality of small cells is used, the terminal device is required to detect each small cell prior to starting communication. Accordingly, in a case where the base station apparatus of a small cell performs massive MIMO transfer, the terminal device has to measure reception quality with respect to beamforming and also detect the small cell. Particularly, the 5G system is expected to have an enormous number of small cells as detection candidates and poses a problem that enormous load is exerted on the terminal device.

The present invention is conceived in view of such circumstances, and an object thereof is to provide a base station apparatus, a terminal device, and a communication method that can realize a small cell network while reducing load on the terminal device, the small cell network including a small cell performing massive MIMO transfer.

### Solution to Problem

A base station apparatus, a terminal device, and a communication method according to the present invention for resolving the above problems are as follows.

(1) That is, a base station apparatus of the present invention is characterized as a second base station apparatus included in a communication system in which a plurality of the second base station apparatuses capable of acquiring information from a first base station apparatus communicates with a terminal device, in which the same cell identification number as at least one of the other second base station apparatuses is configured, a codebook that describes a plurality of types of information is included, and the plurality of types of information is assigned different indexes.

(2) A base station apparatus of the present invention is characterized as the base station apparatus according to (1), in which at least a part of assignment of the indexes is different from the other second base station apparatuses.

(3) A base station apparatus of the present invention is characterized as the base station apparatus according to (1) or (2), in which assignment of the indexes is determined on the basis of communication quality of the communication system.

(4) A base station apparatus of the present invention is characterized as the base station apparatus according to (1) or (2) including a reception unit that receives a signal transmitted from the other second base station apparatuses, in which the state of assignment of the indexes in the other second base station apparatuses is acquired on the basis of the signal transmitted from the other second base station apparatuses, and assignment of the indexes in the base station apparatus is determined on the basis of the state of assignment of the indexes in the other second base station apparatuses.

(5) A base station apparatus of the present invention is characterized as the base station apparatus according to (1) or (2), in which assignment of the indexes is determined on the basis of information that is correlated with assignment of the indexes and signaled from the first base station apparatus.

(6) A base station apparatus of the present invention is characterized as the base station apparatus according to (1) or (2), in which a synchronization signal that is correlated with the cell identification number is transmitted after first precoding of the synchronization signal based on the codebook.

(7) A base station apparatus of the present invention is characterized as a first base station apparatus included in a communication system in which a plurality of second base station apparatuses capable of acquiring information from the first base station apparatus communicates with a terminal device, in which the second base station apparatus includes a codebook describing a plurality of types of information and is capable of assigning different indexes to the plurality of types of information, the plurality of second base station apparatuses is separated into a plurality of groups, a cell identification number of the second base station apparatus is determined on the basis of the separation, and assignment of the indexes and information related to the cell identification number are signaled to the second base station apparatus.

(8) A base station apparatus of the present invention is characterized as the base station apparatus according to (7) including a reception unit that receives a signal transmitted from the second base station apparatus, in which the state of assignment of the indexes in the second base station apparatus is acquired on the basis of the signal transmitted from the second base station apparatus, and assignment of the indexes is determined on the basis of the state of assignment of the indexes in the second base station apparatus.

(9) A base station apparatus of the present invention is characterized as the base station apparatus according to (7), in which assignment of the indexes is determined on the basis of communication quality of the communication system.

(10) A terminal device of the present invention is characterized as a terminal device included in a communication system in which a plurality of second base station apparatuses capable of acquiring information from a first base station apparatus communicates with the terminal device, in which the second base station apparatus includes a codebook describing a plurality of types of information and is capable of assigning different indexes to the plurality of types of information, the first base station apparatus determines assignment of the indexes and signals at least one of the indexes to the terminal device, and reception quality for a signal transmitted from the second base station apparatus is measured on the basis of the signaling from the first base station apparatus.

(11) A communication method of the present invention is characterized as a communication method for a second base station apparatus included in a communication system in which a plurality of the second base station apparatuses capable of acquiring information from a first base station apparatus communicates with a terminal device, in which the second base station apparatus is configured to have the same cell identification number as at least one of the other second base station apparatuses and includes a codebook describing a plurality of types of information, and the communication method includes a step of assigning different indexes to the plurality of types of information.

(12) A communication method of the present invention is characterized as a communication method for a first base station apparatus included in a communication system in which a plurality of second base station apparatuses capable of acquiring information from the first base station apparatus communicates with a terminal device, in which the second base station apparatus includes a codebook describing a plurality of types of information and is capable of assigning different indexes to the plurality of types of information, and the communication method includes a step of separating the plurality of second base station apparatuses into a plurality of groups, a step of determining a cell identification number of the second base station apparatus on the basis of the separation, and a step of signaling assignment of the indexes and information related to the cell identification number to the second base station apparatus.

### Advantageous Effects of Invention

According to the present invention, a small cell network that includes a small cell performing massive MIMO transfer is realized while load on a terminal device is reduced. Consequently, the throughput of a communication system can be improved.

### BRIEF DESCRIPTION OF DRAWINGS

FIG. 1 is a diagram illustrating an example of a communication system according to the present invention.

FIG. 2 is a sequence chart illustrating one example of communication of the present invention.

FIG. 3 is a schematic block diagram illustrating one configuration example of a base station apparatus of the present invention.

FIG. 4 is a schematic block diagram illustrating one configuration example of the base station apparatus of the present invention.

FIG. 5 is a schematic block diagram illustrating one configuration example of a terminal device of the present invention.

FIG. 6 is a schematic block diagram illustrating one configuration example of the base station apparatus of the present invention.

FIG. 7 is a diagram illustrating one example of beam forming of the present invention.

FIG. 8 is a diagram illustrating one example of beam forming of the present invention.

FIG. 9 is a schematic block diagram illustrating one configuration example of the base station apparatus of the present invention.

### DESCRIPTION OF EMBODIMENTS

### 1. First Embodiment

A communication system in the present embodiment includes a base station apparatus (a transmission device, a cell, a transmission point, a transmission station, a transmit antenna group, a transmit antenna port group, a component carrier, or an evolved node B (eNB)) and a terminal device (a terminal, a mobile terminal, a reception point, a reception station, a reception terminal, a reception device, a receive antenna group, a receive antenna port group, or user equipment (UE)).

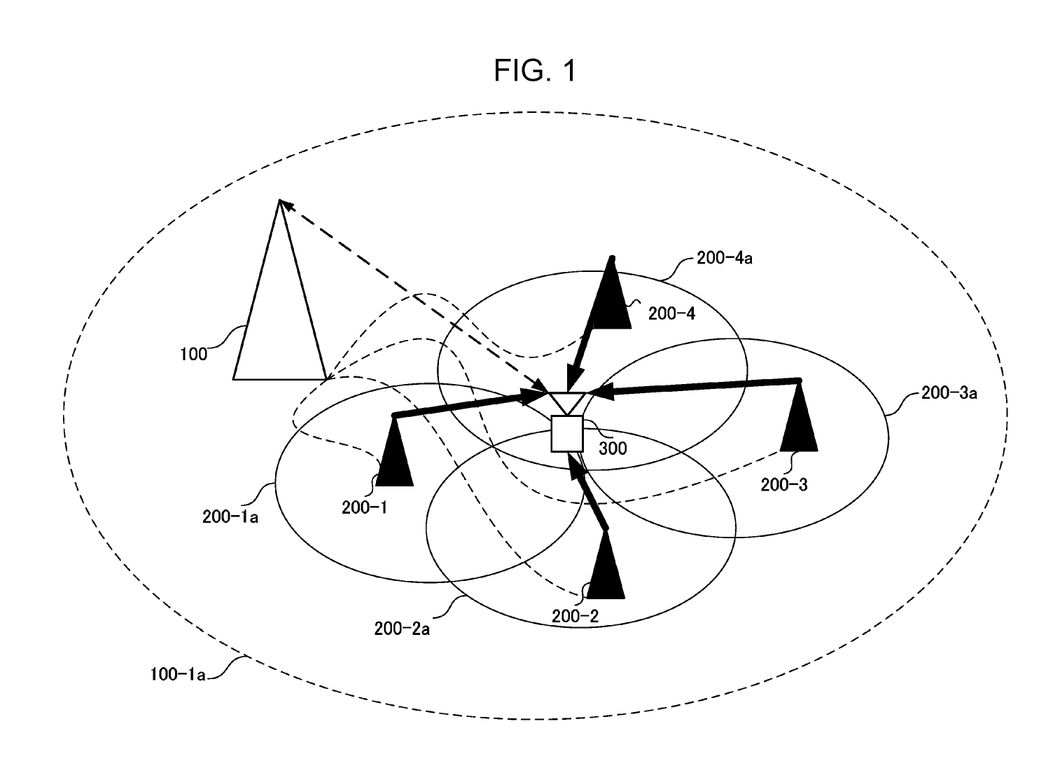

FIG. 1 is a schematic diagram illustrating one example of a downlink of a cellular system according to a first embodiment of the present invention. The cellular system of FIG. 1 includes a wide coverage (having a large cell radius) base station apparatus (called a macro base station apparatus or a first base station apparatus as well) 100, comparatively narrow coverage (having a small cell radius) base station apparatuses (called small base station apparatuses or second base station apparatuses as well) 200-1, 200-2, 200-3, and 200-4, and a terminal device 300. Hereinafter, the small base station apparatuses 200-1 to 200-4 may be simply described as small base station apparatuses 200. A reference sign 100a is the coverage (macrocell) of the macro base station apparatus 100, and reference signs 200-1a, 200-2a, 200-3a, and 200-4a are respectively the coverages (small cells) of the small base station apparatuses 200-1, 200-2, 200-3, and 200-4.

The terminal device 300 is in a state connected to the macro base station apparatus 100 and can exchange control information (assistance information) and the like with the macro base station apparatus 100 by wireless communication. A communication method and a carrier frequency that the terminal device 300 and the macro base station apparatus 100 use in communication are not limited. For example, the terminal device 300 is connected to one of component carriers as a primary cell (pcell) in order to communicate with the macro base station apparatus 100.

Each small base station apparatus 200 is in a state connected to the macro base station apparatus 100 and can exchange control information (assistance information) and the like with the macro base station apparatus 100 by wireless communication or wired communication. A communication method and a carrier frequency that the small base station apparatus 200 and the macro base station apparatus 100 use in communication are not limited. For example, the X2 interface may be used.

In the communication system for which the present embodiment is intended, the macro base station apparatus 100 transmits data destined for the terminal device 300 through the small base station apparatus 200. (Hereinafter, a device A transmitting data destined for a device (device B) through another device (device C) may be described as the device A offloading data of the device C to the device B.) The small base station apparatus 200 transmits information destined for the terminal device 300 by using massive multiple input multiple output (massive MIMO) transfer and using a high frequency band carrier frequency. For example, the small base station apparatus 200 can include in advance a codebook describing a plurality of linear filters and can perform beamforming transmission (precoding transmission) by selecting one from the linear filters described in the codebook, multiplying the linear filter by a transmit signal, and transmitting the transmit signal. (Hereinafter, selecting a linear filter may be described as selecting a beam.)

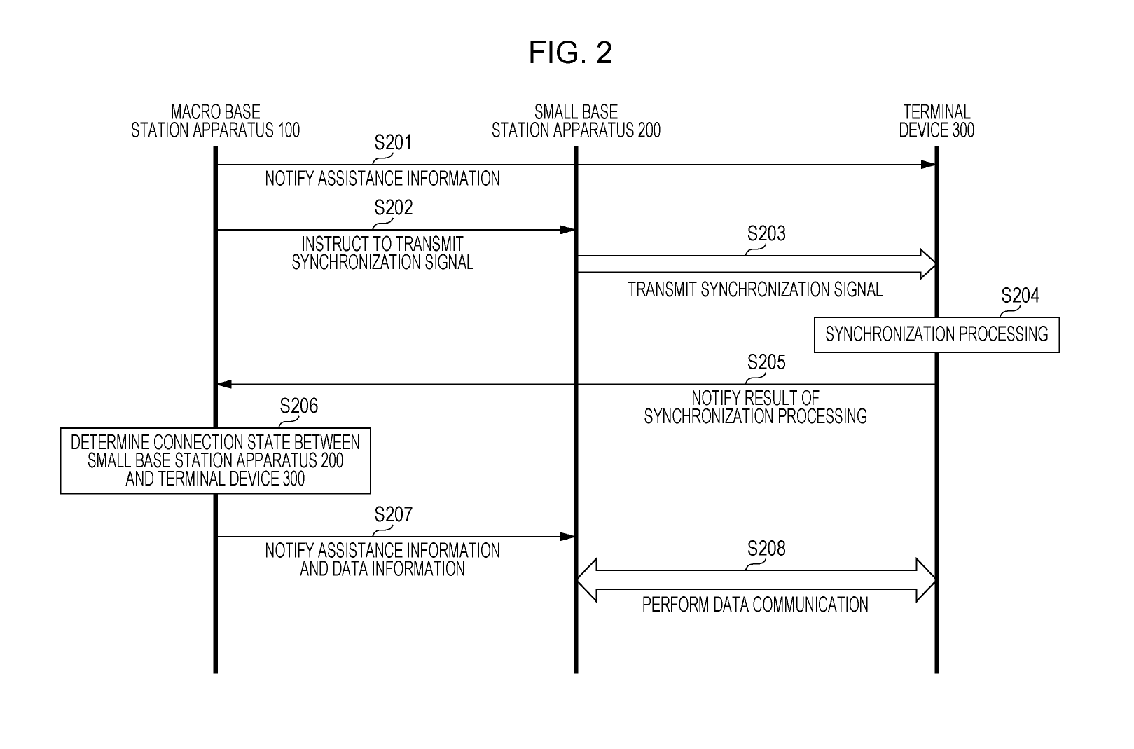

FIG. 2 is a sequence chart illustrating one example of communication according to the present embodiment. Initially, the macro base station apparatus 100 notifies the terminal device 300 of assistance information related to the small base station apparatus 200 (step S201). The assistance information includes information that is correlated with a synchronization signal transmitted by the small base station apparatus 200 (a signal sequence used, information related to radio resources, and the like). While details will be described later, the macro base station apparatus 100 can signal the assistance information to the terminal device 300 by using a radio resource control (RRC) signal or the like, that is, using a higher layer. The step S201 may not be necessarily performed in a case where the terminal device 300 can perform signal processing, described later, without requiring the assistance information.

Next, the macro base station apparatus 100 instructs the small base station apparatus 200 to transmit a synchronization signal (step S202). The small base station apparatus 200 transmits a synchronization signal to the terminal device 300 in accordance with the instruction from the macro base station apparatus 100 (step S203). The small base station apparatus 200 may periodically transmit a synchronization signal independently of an instruction from the macro base station apparatus 100. In this case, the step S202 may not be necessarily performed.

Communication between the small base station apparatus 200 and the terminal device 300 is performed by using a high frequency band carrier frequency. Thus, the small base station apparatus 200 uses massive MIMO transfer to transmit a synchronization signal. For example, the small base station apparatus 200 may determine a beam used for transmission of a synchronization signal on the basis of the assistance information from the macro base station apparatus 100 or may select one or a plurality from a plurality of beams transmittable by the small base station apparatus 200 and use the selected beam to perform single transmission or multiple transmission of a synchronization signal.

The synchronization signal transmitted by the small base station apparatus 200 includes information that allows the small base station apparatus 200 to be detected by the terminal device 300 detecting the synchronization signal. For example, a signal sequence used in the synchronization signal is determined on the basis of cell identification number (cell recognition number or cell ID) that is configured for each cell in order to distinguish a plurality of cells. The terminal device 300, by detecting the synchronization signal transmitted by the small base station apparatus 200, can perform synchronization processing and using the signal sequence used in synchronization processing to recognize the cell ID of a cell to which the terminal device 300 is connected.

First, a method in the related art regarding the cell ID will be described. The cell ID is information that is configured in order to distinguish a plurality of cells included in the communication system. Thus, generally, different cell IDs are configured for each cell. According to the above synchronization signal transmission method, the terminal device 300 can perform trial synchronization processing on the basis of signal sequences (synchronization signal sequences) correlated with the cell IDs of all cells having the possibility of being connected with the terminal device 300, and can recognize the cell ID of a cell connectable from the terminal device 300 by detecting a synchronization signal sequence that exhibits the highest synchronization accuracy. Accordingly, as the number of cells included in the communication system, in other words, the number of synchronization signal sequences, is increased, load related to synchronization processing of the terminal device 300 is increased. The small base station apparatus 200 according to the present embodiment can use different synchronization signal sequences for each of a plurality of beams transmittable by the small base station apparatus 200 when transmitting a synchronization signal by using massive MIMO transfer. In this case, the terminal device 300 is required to perform synchronization processing for not only each small base station apparatus 200 but also each beam.

Therefore, the macro base station apparatus 100 or the like configures the same cell ID in the small base station apparatuses 200-1 to 200-4 included in the communication system according to the present embodiment. That is, each small base station apparatus 200 transmits a synchronization signal in which the same synchronization signal sequence is used. By controlling the small base station apparatus 200 as such, the terminal device 300 is not required to perform synchronization processing for each of the plurality of small base station apparatuses 200, and the complexity thereof is significantly improved.

Returning to FIG. 2, the terminal device 300 performs synchronization processing on the basis of the synchronization signal transmitted by the small base station apparatus 200 (step S204). For example, the terminal device 300 can perform synchronization processing by acquiring a correlation between the synchronization signal sequence and the synchronization signal transmitted by the small base station apparatus 200 by using the synchronization signal sequence acquired on the basis of the assistance information or the like from the macro base station apparatus 100. The terminal device 300 notifies the macro base station apparatus 100 of the result of synchronization processing (step S205). For example, the terminal device 300 can notify the macro base station apparatus 100 of the cell ID detected by synchronization processing or information related to reception quality acquired by synchronization processing, by using a physical uplink shared channel (PUSCH) or a physical uplink control channel (PUCCH) in which the pcell transmits uplink data.

The macro base station apparatus 100 determines the connection state of the terminal device 300 on the basis of the information notified from the terminal device 300 (step S206). In a case where the macro base station apparatus 100 determines that the terminal device 300 is connectable with any small base station apparatus 200, the macro base station apparatus 100 offloads data destined for the terminal device 300 to the small base station apparatus 200 (step S207). A connectable state includes, for example, a state where the terminal device 300 is connectable to one of component carriers as a secondary cell (scell) in order to communicate with the small base station apparatus 200.

The step S207 may include notification of the assistance information to the small base station apparatus 200 by the macro base station apparatus 100. The assistance information can include information related to beamforming that is required when data that is destined for the terminal device 300 and is offloaded from the macro base station apparatus 100 is transmitted by the small base station apparatus 200 using a physical downlink shared channel (PDSCH) in which downlink data of the scell is transmitted.

The small base station apparatuses 200-1 to 200-4 transmit, to the terminal device 300 by using massive MIMO transfer, data that is destined for the terminal device 300 and is offloaded from the macro base station apparatus 100 (step S208). For example, the small base station apparatus 200 can perform massive MIMO transfer when transmitting data destined for the terminal device 300 by using the PDSCH of the scell.

The small base station apparatus 200 can transmit a control signal (for example, a signal that is transmitted in a physical downlink control channel (PDCCH) or an enhanced physical downlink control channel (EPDCCH) of a downlink of the scell) to the terminal device 300 by using massive MIMO transfer. Along with the step S208, the macro base station apparatus 100 may notify the terminal device 300 of the assistance information that the terminal device 300 uses in order to demodulate a signal transmitted from the small base station apparatus 200. One example of communication according to the present embodiment is described heretofore.

[1.1 Macro Base Station Apparatus]

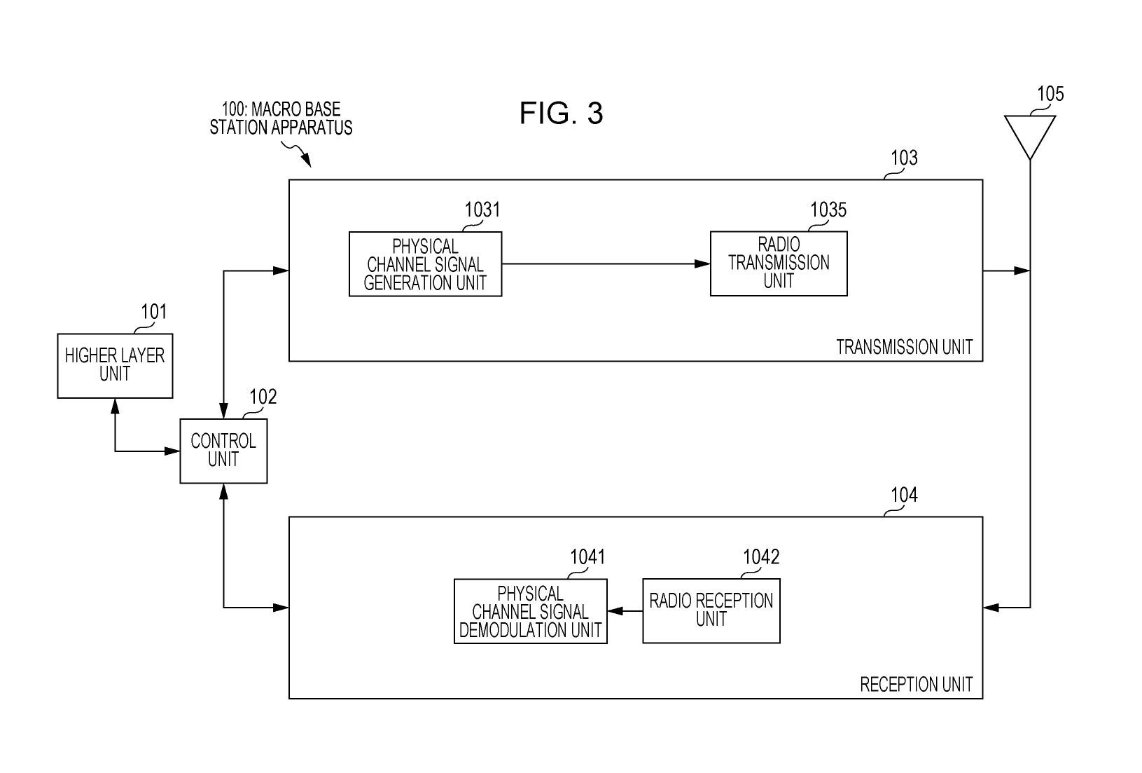

FIG. 3 is a block diagram illustrating one configuration example of the macro base station apparatus 100 according to the first embodiment of the present invention. As illustrated in FIG. 3, a base station apparatus 1 includes a higher layer unit 101, a control unit 102, a transmission unit 103, a reception unit 104, and an antenna 105.

The higher layer unit 101 performs processing in a medium access control (MAC) layer, a packet data convergence protocol (PDCP) layer, a radio link control (RLC) layer, and a radio resource control (RRC) layer. The higher layer unit 101 generates information for controlling the transmission unit 103 and the reception unit 104 and outputs the information to the control unit 102. The higher layer unit 101 can perform configuring a cell ID for the small base station apparatus 200, generating the assistance information for the small base station apparatus 200 and the terminal device 300, and the like described later.

The higher layer unit 101 configures a cell ID in the small base station apparatus 200. In the present embodiment, the higher layer unit 101 of the macro base station apparatus 100 can configure the same cell ID in all of the small base station apparatuses 200 that are in a state connected with the macro base station apparatus 100. In addition, the higher layer unit 101 can separate each small base station apparatus 200 in a state connected with the macro base station apparatus 100 into a plurality of groups and configure the same cell ID in the small base station apparatuses 200 belonging to the same group. The assistance information with respect to the small base station apparatus 200 and the terminal device 300 described later can include information that is related to configuring of a cell ID by the higher layer unit 101. The macro base station apparatus 100 can signal information related to a cell ID or the assistance information including the information to each device in a higher layer by using an RRC signal or the like or to each device by using PDCCH or EPDCCH in which control information as to downlink data transfer is transmitted.

The higher layer unit 101 generates the assistance information for the terminal device 300. The higher layer unit 101 can include, in the assistance information, information that the terminal device 300 uses for performing synchronization processing with respect to the small base station apparatus 200. For example, the assistance information can include information related to a synchronization signal sequence used in synchronization processing by the terminal device 300 (a signal sequence or a cell ID correlated with a synchronization signal sequence), information related to the start timing of synchronization processing of the terminal device 300, information related to the cycle of synchronization processing of the terminal device 300, and the like.

The higher layer unit 101 determines the connection state of the terminal device 300 with respect to the small base station apparatus 200 on the basis of notified information from the terminal device 300 acquired by the reception unit 104. For example, in a case where the macro base station apparatus 100 is notified of information related to a cell ID that is detected by synchronization processing of the terminal device 300, the higher layer unit 101 can determine that the terminal device 300 is in a connectable state with respect to the small base station apparatus 200 if the cell ID acquired from the information is included in the cell ID configured in the small base station apparatus 200.

The higher layer unit 101 generates the assistance information for the small base station apparatus 200. The higher layer unit 101 can include, in the assistance information, information related to the cell ID configured in each small base station apparatus 200, the timing or cycle of transmission of a synchronization signal by the small base station apparatus 200, information related to a beam used in transmission of a synchronization signal by the small base station apparatus 200, and the like.

The macro base station apparatus 100 can offload a part of data destined for the terminal device 300 to the small base station apparatus 200 in a case where the higher layer unit 101 determines that the terminal device 300 is in a connectable state with respect to the small base station apparatus 200. The higher layer unit 101 can include, in the assistance information, information related to data that is destined for the terminal device 300 and is offloaded to the small base station apparatus 200, and information related to a beam that is used when the small base station apparatus 200 transmits the data to the terminal device 300. The small base station apparatuses 200 having the same cell ID configured preferably transmit data to the terminal device 300 at the same time. Thus, the assistance information may include information related to radio resources used in transmission of the offloaded data.

The transmission unit 103 generates a transmit signal that includes the above assistance information generated by the higher layer unit 101. The transmit signal generated by the transmission unit 103 may be transmitted by wireless communication to the small base station apparatus 200 or the terminal device 300 through the antenna 105. In this case, a physical channel signal generation unit 1031 included in the transmission unit 103 generates a baseband signal that includes the assistance information, and a radio transmission unit 1035 included in the transmission unit 103 converts the baseband signal into a radio frequency band transmit signal. The transmit signal including the assistance information may be transmitted by wired communication and, for example, may be transmitted through the X2 interface to the small base station apparatus 200.

The reception unit 104 acquires a signal transmitted from the small base station apparatus 200 or the terminal device 300, and as a method for acquisition of the signal, the reception unit 104 may receive the signal through the antenna 105. In this case, a radio reception unit 1042 included in the reception unit 104 converts a radio frequency band receive signal received through the antenna 105 into a baseband signal. A physical channel signal demodulation unit 1041 included in the reception unit 104 demodulates the baseband signal. A signal from the small base station apparatus 200 or the terminal device 300 may be received by the reception unit 104 by wired communication.

The reception unit 104 can acquire information related to a cell ID detected by synchronization processing of the terminal device 300 from a signal transmitted by the terminal device 300 to the macro base station apparatus 100, and the information related to a cell ID acquired by the reception unit 104 is passed to the higher layer unit 101 through the control unit 102.

[1.2 Small Base Station Apparatus]

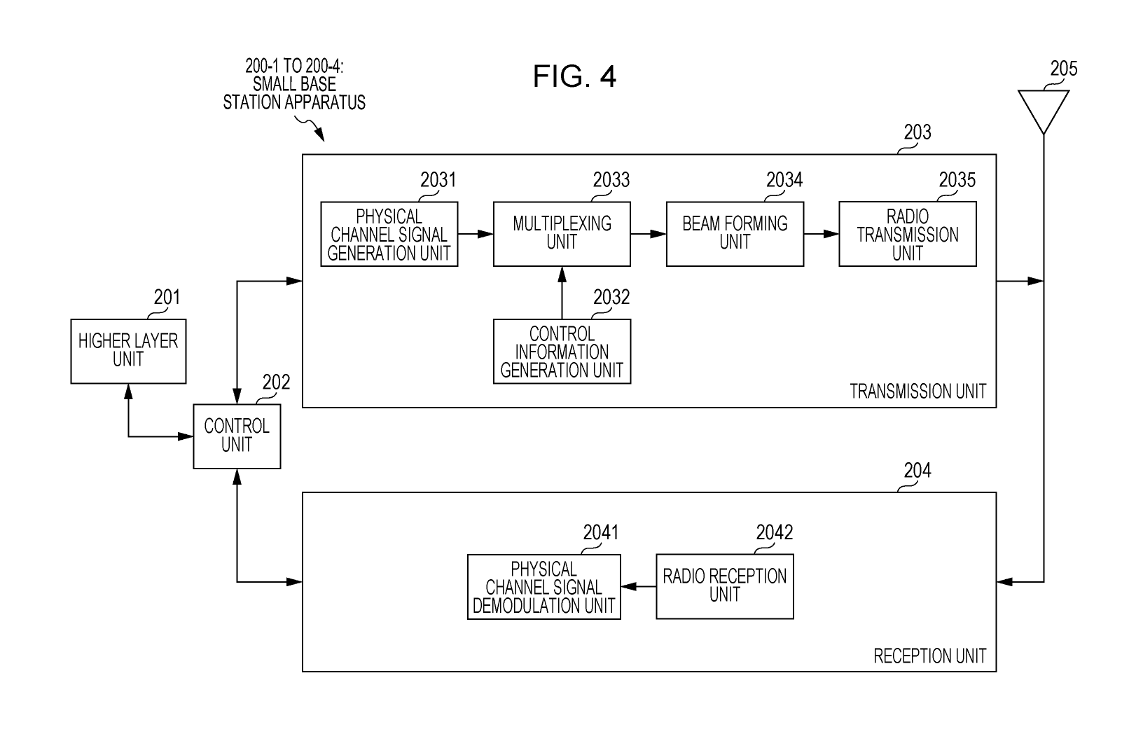

FIG. 4 is a block diagram illustrating one configuration example of the small base station apparatus 200 according to the first embodiment of the present invention. As illustrated in FIG. 4, the small base station apparatus 200 includes a higher layer unit 201, a control unit 202, a transmission unit 203, a reception unit 204, and an antenna 205. The transmission unit 203 includes a physical channel signal generation unit 2031, a control information generation unit 2032, a multiplexing unit 2033, a beam forming unit 2034, and a radio transmission unit 2035.

The higher layer unit 201 performs processing in the MAC layer, the PDCP layer, the RLC layer, and the RRC layer. The higher layer unit 201 generates information for controlling the transmission unit 203 and the reception unit 204 and outputs the information to the control unit 202.

The reception unit 204 can acquire the assistance information notified from the macro base station apparatus 100. In the same manner as the reception unit 104 of the macro base station apparatus 100, the reception unit 204 can acquire the assistance information by wireless communication or wired communication, and operation of a physical channel signal demodulation unit 2041 and a radio reception unit 2042 at this point is the same as operation of the physical channel signal demodulation unit 1041 and the radio reception unit 1042. The assistance information acquired by the reception unit 204 is passed to the higher layer unit 201 or the transmission unit 203 through the control unit 202.

The small base station apparatus 200 has a function of transmitting a synchronization signal to the terminal device 300. For this function, the control information generation unit 2032 generates a synchronization signal transmitted to the terminal device 300 on the basis of the assistance information from the macro base station apparatus 100 acquired by the reception unit 204, a control signal generated by the higher layer unit 201, and the like. For example, the control information generation unit 2032 can generate a synchronization signal sequence used in a synchronization signal on the basis of the cell ID configured from the macro base station apparatus 100 and can generate a baseband synchronization signal on the basis of the generated signal sequence. At this point, the small base station apparatuses 200 that are included in the communication system and have the same cell ID configured can generate the same synchronization signal. The control information generation unit 2032 may use a generation method and a transmission method for a signal of a synchronization channel of an LTE system (for example, a primary synchronization signal (PSS) or a secondary synchronization signal (SSS)) in a generation method and a transmission method for the synchronization signal.

The synchronization signal generated by the control information generation unit 2032 is input into the multiplexing unit 2033 and is arranged to an appropriate radio resource along with the baseband signal (described in detail later) generated by the physical channel signal generation unit 2031. The terminal device 300 desirably recognizes in advance the radio resource to which the synchronization signal is arranged.

A baseband signal generated by the multiplexing unit 2033 is input into the beam forming unit 2034. The beam forming unit 2034 performs signal processing in order to perform beamforming (precoding) transmission of a synchronization signal.

A beamforming method that the beam forming unit 2034 applies to a synchronization signal is not limited. For example, the beam forming unit 2034 can include in advance a codebook describing a plurality of linear filters and can select one or a plurality from the linear filters described in the codebook and multiply the linear filter by a synchronization signal. The beam forming unit 2034 may determine a beam used in transmission of a synchronization signal on the basis of the assistance information from the macro base station apparatus 100.

In a case where the reception unit 204 can receive a radio frequency band signal transmitted from the terminal device 300, a beam may be formed on the basis of the signal. For example, in a case where the reception unit 204 can acquire the arrival angle of the signal (reception weight coefficient), the beam forming unit 2034 can use a beam having an angle of departure close to the arrival angle in transmission of a synchronization signal.

In the present embodiment, a baseband signal different from a synchronization signal may be multiplexed with a synchronization signal and input into the beam forming unit 2034. At this point, the beam forming unit 2034 may use the same beam or may use different beams for the synchronization signal and the baseband signal. Hereinafter, beamforming processing (precoding processing) performed for a synchronization signal in the beam forming unit 2034 may be described as first precoding, and a linear filter used in the first precoding may be described as a first linear filter. Beamforming processing (precoding processing) performed for a baseband signal (for example, a data signal) different from a synchronization signal in the beam forming unit 2034 may be described as second precoding, and a linear filter used in the second precoding may be described as a second linear filter. The beam forming unit 2034 may include in advance a plurality of codebooks in which at least a part of a plurality of linear filters described is different, and may perform control to perform beamforming transmission on the basis of different codebooks when the small base station apparatus 200 transmits the synchronization signal and the baseband signal by beamforming. The beam forming unit 2034 may perform control to transmit the baseband signal by using a plurality of beams in the same manner as the synchronization signal when the small base station apparatus 200 transmits the baseband signal different from the synchronization signal by beamforming.

The present invention also includes a case where the beam forming unit 2034 recognizes only a calculation method for a linear filter used in beamforming. For example, the beam forming unit 2034 may randomly generate a plurality of linear filters prior to the synchronization signal for the terminal device 300 and may perform a series of signal processing on the basis of the linear filters. The beam forming unit 2034 may update the content described in the codebook each time a linear filter is generated.

The radio transmission unit 2035 performs a process of converting the baseband signal generated by the beam forming unit 2034 into a radio frequency (RF) band signal. Processes performed by the radio transmission unit 1034 include digital/analog conversion, filtering, frequency conversion from baseband into RF band, and the like.

The antenna 205 transmits a signal generated by the transmission unit 203 toward the terminal device 300.

In a case where the assistance information acquired by the reception unit 204 includes data that is destined for the terminal device 300 and is offloaded from the macro base station apparatus 100, the data is input into the physical channel signal generation unit 2031, and the physical channel signal generation unit 2031 can generate a baseband signal that can transmit the data. For example, in a case where the terminal device 300 regards the small base station apparatus 200 as an scell in synchronization processing of the terminal device 300 described later, the physical channel signal generation unit 2031 can include the data in a signal that is transmitted in PDSCH of the scell.

[1.3 Terminal Device]

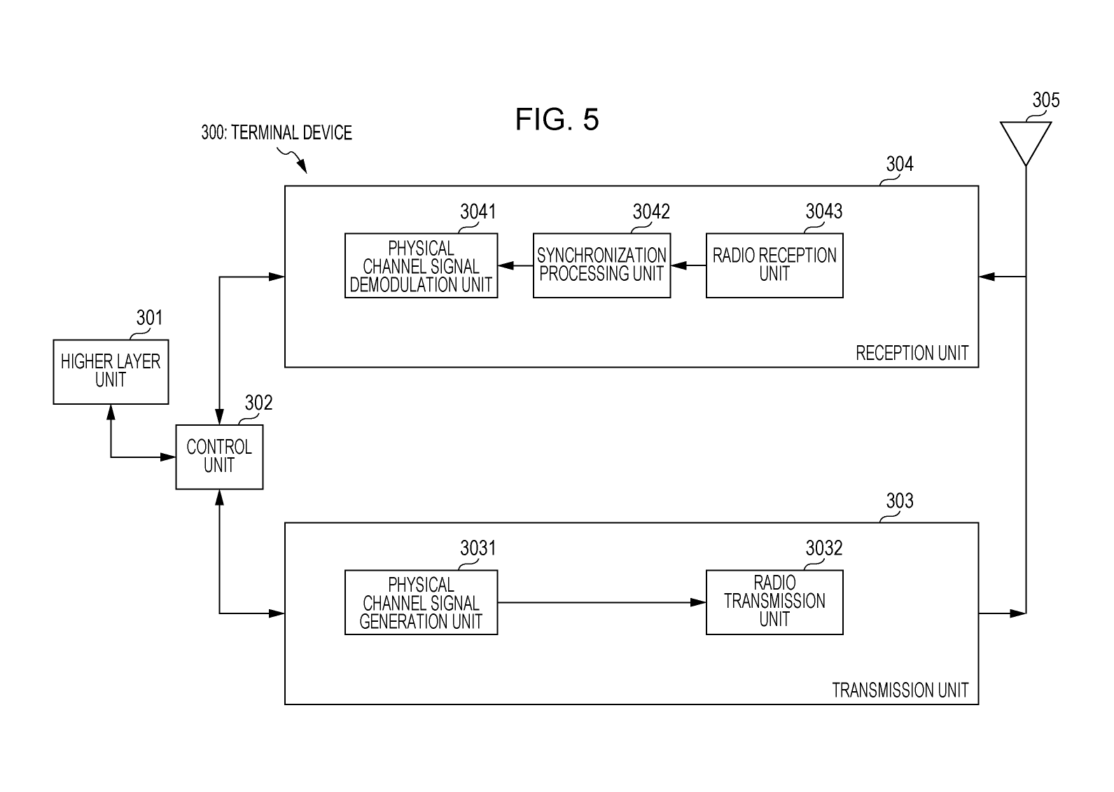

FIG. 5 is a block diagram illustrating one configuration example of the terminal device 300 according to the first embodiment of the present invention. As illustrated in FIG. 5, the terminal device 300 includes a higher layer unit 301, a control unit 302, a transmission unit 303, a reception unit 304, and an antenna 305. The reception unit 304 includes a radio reception unit 3043, a synchronization processing unit 3042, and a physical channel signal demodulation unit 3041.

The higher layer unit 301 performs processing in the MAC layer, the PDCP layer, the RLC layer, and the RRC layer. The higher layer unit 301 generates information for controlling the transmission unit 303 and the reception unit 304 and outputs the information to the control unit 302.

The antenna 305 receives a signal transmitted by the small base station apparatus 200 and outputs the signal to the reception unit 304.

The reception unit 304 includes the physical channel signal demodulation unit 3041, the synchronization processing unit 3042, and the radio reception unit 3043. The radio reception unit 3043 converts an RF band signal input from the antenna 305 into a baseband signal. Processes performed by the radio reception unit 3043 include frequency conversion from RF band into baseband, filtering, analog/digital conversion, and the like.

The reception unit 304 can acquire, in addition to the signal transmitted by the small base station apparatus 200, a signal from the macro base station apparatus 100 with which a connection state is previously established. For example, in a case where the terminal device 300 is connected to the macro base station apparatus 100 as a pcell, the terminal device 300 can acquire the assistance information from a signal that the macro base station apparatus 100 transmits by using PDSCH, PDCCH, or the like of the pcell.

The synchronization processing unit 3042 performs synchronization processing on the basis of a synchronization signal transmitted from the small base station apparatus 200. The synchronization processing unit 3042 can use the assistance information notified from the macro base station apparatus 100 when performing synchronization processing.

The synchronization processing unit 3042 can recognize synchronization signal sequences respectively correlated with a plurality of cell IDs by using the assistance information from the macro base station apparatus 100. Apparently, the synchronization processing unit 3042 can recognize in advance synchronization signal sequences respectively correlated with a plurality of cell IDs that may be connected. The synchronization processing unit 3042 can acquire a correlation between the plurality of signal sequences and a synchronization signal transmitted from the small base station apparatus 200 by using the recognized plurality of signal sequences. For example, in a case where there is a signal sequence having a correlation output greater than a specific threshold, the synchronization processing unit 3042 determines that synchronization can be made (connection can be made) with respect to the small base station apparatus 200 that has a cell ID correlated with the signal sequence (in a case where there is a plurality of the signal sequences, a signal sequence that exhibits the maximum correlation output). The synchronization processing unit 3042 may acquire reception quality that is correlated with each cell ID acquired by synchronization processing, and may perform control to notify the macro base station apparatus 100 of the reception quality through the transmission unit 303 described later.

The terminal device 300 may receive a synchronization signal from not only the small base station apparatus 200 but also the macro base station apparatus 100 or from the small base station apparatus 200 or the macro base station apparatus 100 of the adjacent cell. The terminal device 300 may perform synchronization processing for the synchronization signal transmitted from a device other than the small base station apparatus 200 and may detect a plurality of cell IDs or acquire reception quality. The same applies in a case where the higher layer unit 101 of the macro base station apparatus 100 separates the governed small base station apparatuses 200 thereof into a plurality of groups.

The terminal device 300 that receives a synchronization signal from a plurality of devices is required to perform synchronization processing for each frequency band usable by the communication system. However, in the communication system for which the present embodiment is intended, the small base station apparatus 200 using a high frequency band carrier frequency and the macro base station apparatus 100 using a low frequency band carrier frequency may impose a restriction on a configured cell ID. For example, in a case where cell IDs 0 to 503 are prepared, a situation where the cell IDs 0 to 56 are used for only the macro base station apparatus 100 and the cell IDs 57 to 503 are used by only the small base station apparatus 200 is considered. In this case, the terminal device 300 may perform only synchronization processing corresponding to the cell IDs 0 to 56 for the frequency band used by the macro base station apparatus 100 and meanwhile may perform only synchronization processing corresponding to the cell IDs 57 to 503 for the frequency band used by the small base station apparatus 200. A part of the cell IDs may be used for both of the small base station apparatus 200 and the macro base station apparatus 100. Such control can reduce load on the terminal device 300.

A cell ID detected by the synchronization processing unit 3042 is notified to the higher layer unit 301 and the transmission unit 303 through the control unit 302. The transmission unit 303 notifies the macro base station apparatus 100 of the acquired cell ID. This notification method is not limited. For example, if the terminal device 300 is connected to the macro base station apparatus 100 as a pcell, the terminal device 300 can transmit information related to the cell ID by using PUSCH of the pcell.

In a case where a signal other than a synchronization signal is transmitted from the small base station apparatus 200, the signal is input into the physical channel signal demodulation unit 3041, and demodulation processing is performed.

The macro base station apparatus 100 according to the present embodiment may have the function of the small base station apparatus 200. The small base station apparatus 200 may have the function of the macro base station apparatus 100.

According to the macro base station apparatus 100, the small base station apparatus 200, and the terminal device 300 described heretofore, a wireless communication system that includes a plurality of small base station apparatuses capable of performing massive MIMO transfer and does not require the terminal device 300 to perform complex synchronization processing can be provided.

### 2. Second Embodiment

In massive MIMO transfer that uses a high frequency band carrier frequency, signal transmission is based on beamforming (precoding) transfer. Thus, the transmission performance of beamforming transfer is significantly dependent on a beam forming method. The present embodiment is intended for a case where appropriate beam forming is performed between a plurality of small base station apparatuses assumed in the first embodiment.

A communication system for which the present embodiment is intended is the same as the communication system illustrated in FIG. 1, and the same cell ID from the macro base station apparatus 100 is configured in the small base station apparatuses 200 included in the communication system. In addition, the connection state between each device is the same as the first embodiment. Furthermore, the terminal device 300 is in a connectable state (synchronized state) with any one of the small base station apparatuses 200. For example, the terminal device 300 is connected to the macro base station apparatus 100 as a pcell and the small base station apparatus 200 as an scell.

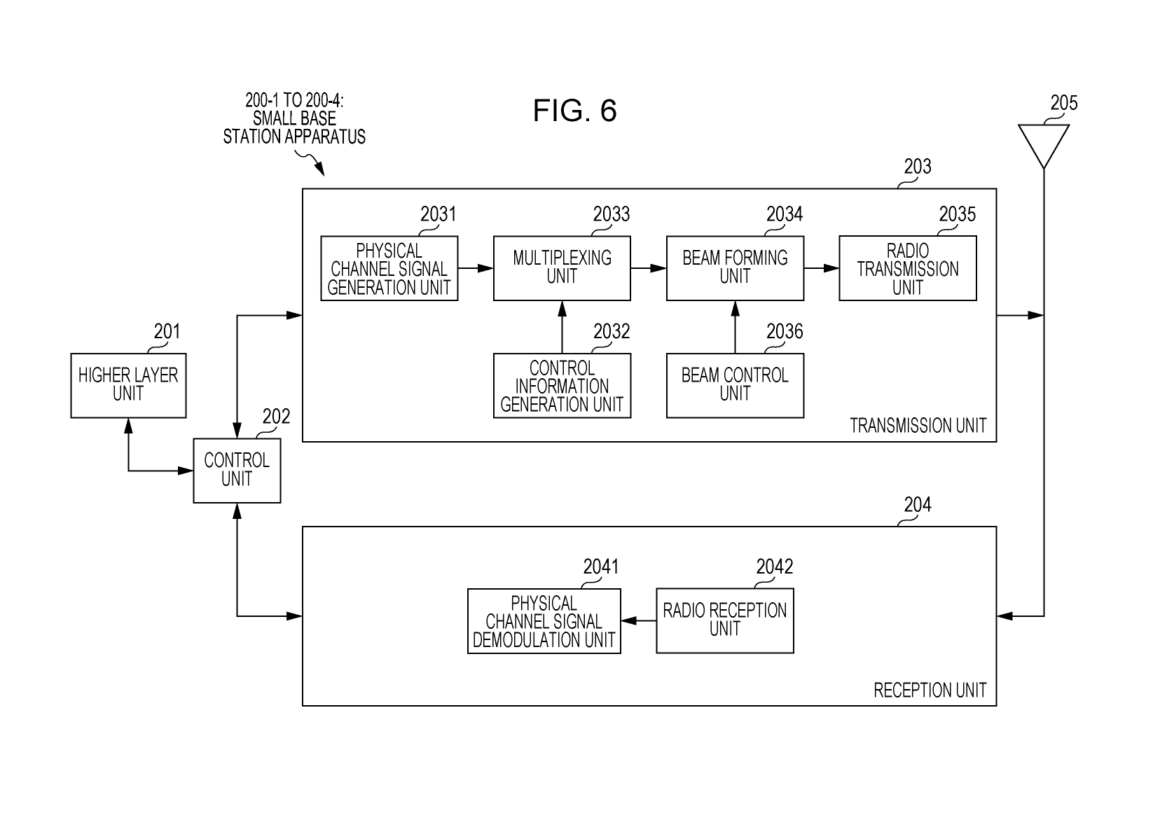

FIG. 6 is a block diagram illustrating one configuration example of the small base station apparatus 200 according to the present embodiment. This configuration is almost the same as the configuration illustrated in FIG. 4. The transmission unit 203 further includes a beam control unit 2036.

The small base station apparatus 200 according to the present embodiment can perform the same beamforming transfer as the first embodiment. A method for beamforming transfer is not limited. For example, there is a method in which a codebook describing a plurality of linear filters is included in advance, one is selected from the linear filters described in the codebook, and the linear filter is multiplied by a transmit signal and is transmitted. For example, in a case where the number of antenna elements of the antenna 205 included in the small base station apparatus 200 is N, an N-row by N-column DFT matrix B illustrated in Expression (1) can be used as the codebook.

$$\begin{matrix}[ Math . 1 ] & \\ B = [ \begin{matrix}{W}^{0 , 0} & {W}^{0 , 1} & … & {W}^{0 , N - 2} & {W}^{0 , N - 1} \\ {W}^{1 , 0} & {W}^{1 , 1} & … & {W}^{1 , N - 2} & {W}^{1 , N - 1} \\ ⋮ & ⋮ & ⋱ & ⋮ & ⋮ \\ {W}^{N - 2 , 0} & {W}^{N - 2 , 1} & … & {W}^{N - 2 , N - 2} & {W}^{N - 2 , N - 1} \\ {W}^{N - 1 , 0} & {W}^{N - 1 , 1} & … & {W}^{N - 1 , N - 2} & {W}^{N - 1 , N - 1}\end{matrix} ] & ( 1 )\end{matrix}$$

Here, W is exp(−j2π/N). The small base station apparatus 200 can form N beams by regarding each column vector of the matrix B as one linear filter. Apparently, an example of the codebook included in the small base station apparatus 200 is not limited to Expression (1). The small base station apparatus 200 may include a codebook created on the basis of Householder transformation employed in LTE, a Grassmannian codebook, or a multiple codebook configured of a plurality of codebooks. The number of linear filters described in the codebook is not required to be the same as the number of antenna elements included in the small base station apparatus 200. The length (number of elements) of a linear filter described in the codebook may be different from the number of antenna elements included in the small base station apparatus 200. Hereinafter, the small base station apparatus 200 includes a codebook describing N linear filters, and the linear filters (called beams as well) described in the codebook will be respectively described as b₁, b₂, . . . , b_{N}.

The beam control unit 2036 of the small base station apparatus 200 determines a linear filter (beam) that the beam forming unit 2034 applies to a transmit signal. The beam control unit 2036 also configures a beam identification number (BID) for identifying a plurality of beams (described in detail later). While a beam selection method for the beam control unit 2036 is not limited in the present embodiment, for example, a method that is based on the idea of random beamforming may be preferably used.

In this method, initially, the small base station apparatus 200 multiplies the plurality of linear filters b₁, b₂, . . . , b_{N} described in the codebook respectively by different reference signals c₁, c₂, . . . , c_{N} and spatially multiplexes and transmits the result of multiplication to the terminal device 300.

The terminal device 300 recognizes in advance the reference signal by which the small base station apparatus 200 multiplies the linear filter, and thus can recognize reception quality for each beam formable by the small base station apparatus 200 by acquiring a correlation between the reference signal transmitted by beamforming by the small base station apparatus 200 and the reference signal recognized by the terminal device 300. That is, the terminal device 300 identifies each beam by using the reference signal. Hereinafter, the beam identification number (BID) of the linear filter (beam) bⱼ that is used in transmission of the reference signal cᵢ will be i. The index of a reference signal and the index of a linear filter are not necessarily required to match. In addition, the number of beams described in the codebook and the number of reference signals are not required to match. Furthermore, one BID may be configured for a plurality of beams, or a plurality of BIDs may be configured for one beam.

The small base station apparatus 200 may transmit a synchronization signal on the basis of the idea of random beamforming. In this case, the small base station apparatus 200 can generate a plurality of synchronization signals in which different synchronization signal sequences are used for each beam, and can spatially multiplex and transmit the plurality of synchronization signals by using different beams. If a synchronization signal sequence is correlated with a BID (for example, the small base station apparatus 200 can correlate a parameter (a generation formula or an initial value) at the time of generating a signal sequence used in a synchronization signal sequence with a BID), the terminal device 300 can recognize reception quality for each BID by performing synchronization processing of a synchronization signal transmitted from the small base station apparatus 200.

The present invention also includes a case where the small base station apparatus 200 recognizes only a calculation method for a linear filter used in beamforming. For example, the small base station apparatus 200 may randomly generate a plurality of linear filters prior to communication with the terminal device 300 and may perform a series of signal processing on the basis of the linear filters. In this case, the small base station apparatus 200 may configure a BID for the plurality of linear filters generated in each communication or may correlate a calculation method for the linear filters with a BID.

The terminal device 300 may directly notify the small base station apparatus 200 of information (for example, a BID) related to a beam for which reception quality is the highest. In addition, since the terminal device 300 is in a state connected with the macro base station apparatus 100 and, furthermore, the macro base station apparatus 100 and the small base station apparatus 200 are in a connected state, the terminal device 300 can notify the small base station apparatus 200 of the information related to the beam through the macro base station apparatus 100. The beam control unit 2036 can determine the optimal beam on the basis of the information related to the beam notified from the terminal device 300.

According to the method described heretofore, the small base station apparatus 200 can perform massive MIMO transfer with respect to the terminal device 300. However, massive MIMO transfer cannot be appropriately performed at all times in a case where the same cell ID is configured in the same manner as the small base station apparatuses 200 according to the present embodiment. The reason is that, in the case of the present embodiment, the terminal device 300 recognizes the plurality of small base station apparatuses 200 having the same cell ID configured as one small base station apparatus 200. Thus, when the small base station apparatus 200 transmits a plurality of reference signals by using different beams, the beams transmitted by each small base station apparatus 200 interfere with each other and are received in the terminal device 300.

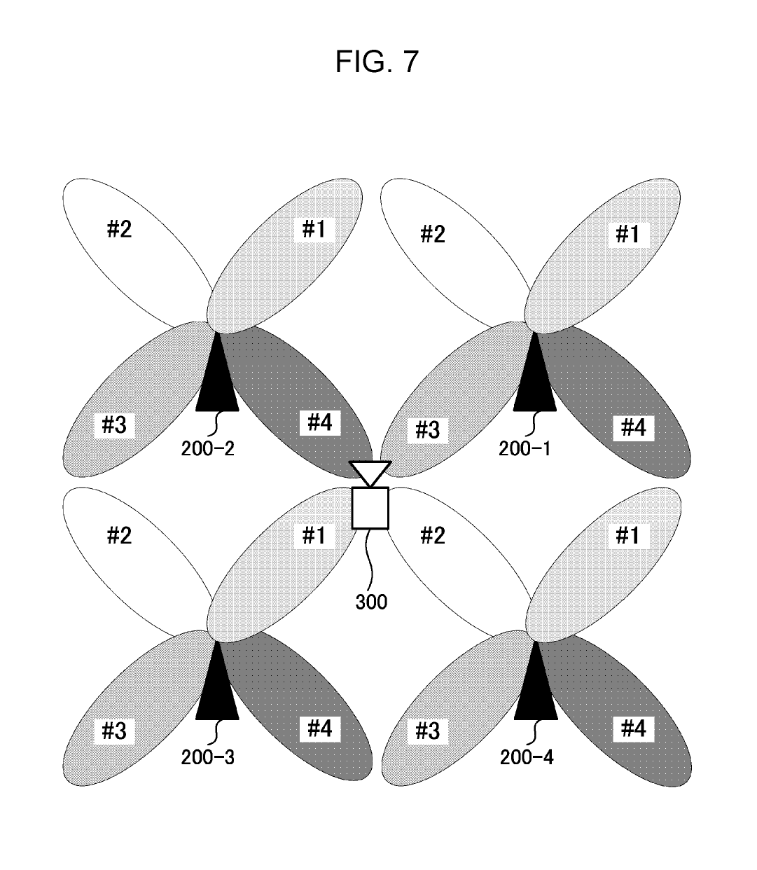

FIG. 7 is a diagram illustrating one example of the state of beam forming of the small base station apparatus 200 according to the present embodiment. Each small base station apparatus 200 shares a codebook that can form four beams b₁, b₂, b₃, and b₄, and transmits four different reference signals at the same time by using the four beams. In addition, BIDs configured for each beam (described as #1, #2, #3, and #4 in FIG. 7) are the same between each small base station apparatus 200. According to the method described previously, the terminal device 300 in FIG. 7 measures quality for each beam and notifies the macro base station apparatus 100 (not described in FIG. 7). However, since the same cell ID is configured in the small base station apparatuses 200, the terminal device 300 cannot determine the small base station apparatus 200 from which each beam is transmitted. Thus, the terminal device 300 determines that four beams having different BIDs are transmitted from the same transmission point. Accordingly, in a case where the terminal device 300 exists in a position as illustrated in FIG. 7, when the terminal device 300 detects a certain beam, another beam interferes, and the terminal device 300 cannot detect a beam for which reception quality is high.

Therefore, the small base station apparatuses 200 included in the communication system for which the present embodiment is intended realize high efficiency massive MIMO transfer by appropriately configuring a codebook or a BID included in each small base station apparatus 200.

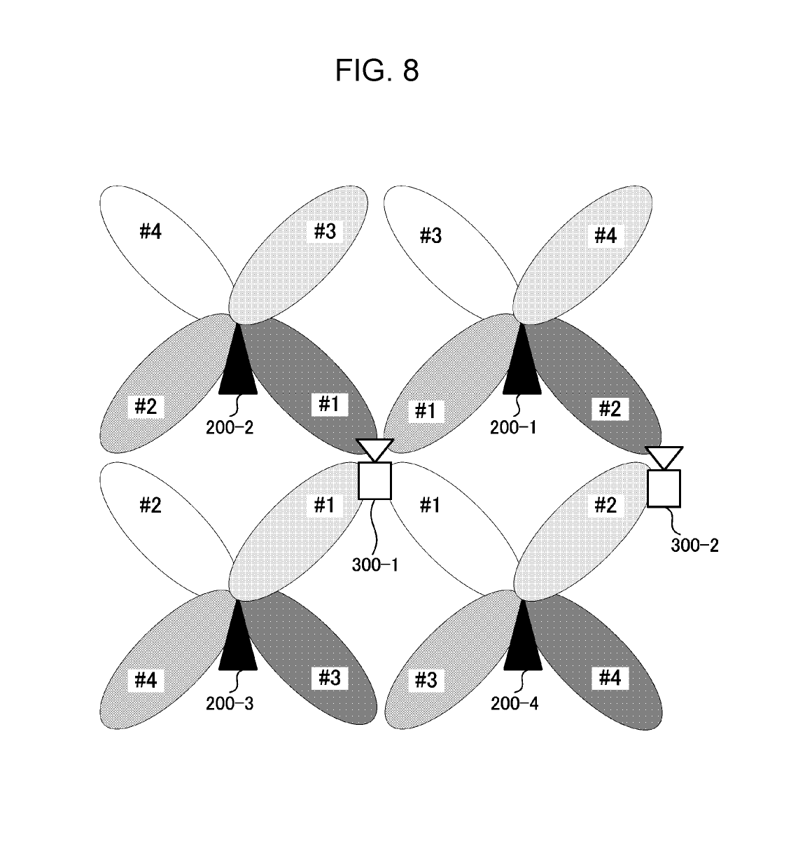

FIG. 8 is a diagram illustrating one example of the state of beam forming of the small base station apparatus 200 according to the present embodiment. Each small base station apparatus 200, in the same manner as FIG. 7, shares the same codebook that can form four beams, but different BIDs are configured for each beam. In addition, a terminal device 300-1 and a terminal device 300-2 exist in FIG. 8. In this case, there is a high possibility that the terminal device 300-1 can detect only a beam of BID=1. In addition, while the terminal device 300-1 cannot recognize, actually the beam of BID=1 is transmitted from the four small base station apparatuses 200 at the same time, and thus the quality of the beam is favorable. Accordingly, the terminal device 300-1 notifies the small base station apparatuses 200 of BID=1 as a desired beam through the macro base station apparatus 100, and the small base station apparatuses 200 perform massive MIMO transfer at the same time with respect to the terminal device 300-1 by using the beam of BID=1, and thereby favorable communication quality is realized.

There is a high possibility that the terminal device 300-2 can detect only a beam of BID=2. In this case, the small base station apparatus 200 uses the beams of BID=1 and BID=2 respectively for beamforming transmission with respect to the terminal device 300-1 and the terminal device 300-2 and thereby can spatially multiplex and transmit data destined for the terminal device 300-1 and the terminal device 300-2.

In a case where another terminal device 300-3 exists near the terminal device 300-1 in FIG. 8, there is a high possibility that the terminal device 300-3 notifies the macro base station apparatus 100 of BID=1 as a desired beam in the same manner as the terminal device 300-1. In this case, the small base station apparatus 200 cannot spatially multiplex and transmit data destined for the terminal device 300-1 and the terminal device 300-3 and is required to multiplex data destined for the terminal device 300-1 and the terminal device 300-3 by using another multiplexing method (for example, time division multiplexing or frequency division multiplexing). In this case, the communication opportunity for the terminal device 300 is decreased. In this case, the small base station apparatus 200 configures a BID as illustrated in FIG. 7, and the possibility that the terminal device 300-1 and the terminal device 300-3 notify different desired BIDs is increased.

Thus, the small base station apparatus 200 can spatially multiplex and transmit data destined for the terminal device 300-1 and the terminal device 300-3. However, data of the terminal device 300-1 and data of the terminal device 300-3 interfere with each other, and thus reception quality is decreased compared with the case in FIG. 8. That is, in the communication system for which the present embodiment is intended, the communication opportunity and the reception quality of the terminal device 300 can be controlled by the beam control unit 2036 of each small base station apparatus 200 controlling a BID, but the communication opportunity and the reception quality are in a trade-off relationship.

In the communication system for which the present embodiment is intended, a BID is appropriately configured according to an environment in which the small base station apparatus 200 is installed. For example, in a region where the terminal device 300 is densely located, the communication opportunity of the terminal device 300 in the region can be improved by each small base station apparatus 200 configuring a BID in such a manner that beams having different BIDs reach the region from the small base station apparatuses 200 included in the communication system. Meanwhile, in a region where the density of the terminal device 300 is not that high, the communication quality of the terminal device 300 in the region can be improved by each small base station apparatus 200 configuring a BID in such a manner that beams having the same BID reaches the region from the small base station apparatuses 200 included in the communication system.

If the terminal device 300 having a large amount of data traffic exists in the region where the terminal device 300 is densely located, communication of the terminal device 300 having a large data traffic is finished in a small amount of time by each small base station apparatus 200 configuring a BID in such a manner that beams having the same BID reaches from the small base station apparatuses 200 included in the communication system. Thus, the overall communication efficiency of the communication system may be improved.

As described heretofore, in the communication system for which the present embodiment is intended, the beam control unit 2036 of the small base station apparatus 200 appropriately configures a BID according to the environment in which the small base station apparatus 200 is installed (or the density of the terminal device 300, the amount of traffic and the content of traffic of each terminal device 300, the reception quality of the terminal device 300, or the like).

Configuration of a BID by the beam control unit 2036 of the small base station apparatus 200 can be configured by considering an ambient environment when a telecommunications carrier installs the small base station apparatus 200. In addition, the beam control unit 2036 can configure a BID in accordance with an instruction from the higher layer unit 101 of the macro base station apparatus 100 to which the small base station apparatus 200 is connected.

While each small base station apparatus 200 includes the same codebook and configures a BID in the description provided heretofore, each small base station apparatus 200 may use different codebooks to perform the same control.

In a case where the small base station apparatus 200 uses the same codebook in beamforming transmission of a synchronization signal and beamforming transmission of a signal other than a synchronization signal (for example, a data signal), configuration of a BID at the time of each transmission may be differently performed.

According to the small base station apparatus 200 described heretofore, massive MIMO transfer can be highly efficiently performed in a communication system that includes a plurality of small base station apparatuses having the same cell ID configured. Thus, the system throughput of the communication system can be improved.

### 3. Third Embodiment

In the communication system for which the second embodiment is intended, the overall efficiency of the system is improved by appropriately configuring, according to the environment in which the small base station apparatus is installed, a beam identification number for identifying a plurality of beams that the small base station apparatus uses in massive MIMO transfer. However, the environment of the communication system usually changes constantly, and one pattern for configuring a beam identification number cannot cope with every environment. In the present embodiment, the small base station apparatus dynamically configures a beam identification number for identifying a plurality of beams used in massive MIMO transfer.

A communication system for which the present embodiment is intended is the same as the communication system illustrated in FIG. 1, and the same cell ID from the macro base station apparatus 100 is configured in the small base station apparatuses 200 included in the communication system. In addition, the connection state between each device is the same as the first embodiment. Furthermore, the terminal device 300 is in a connectable state (synchronized state) with any one of the small base station apparatuses 200.

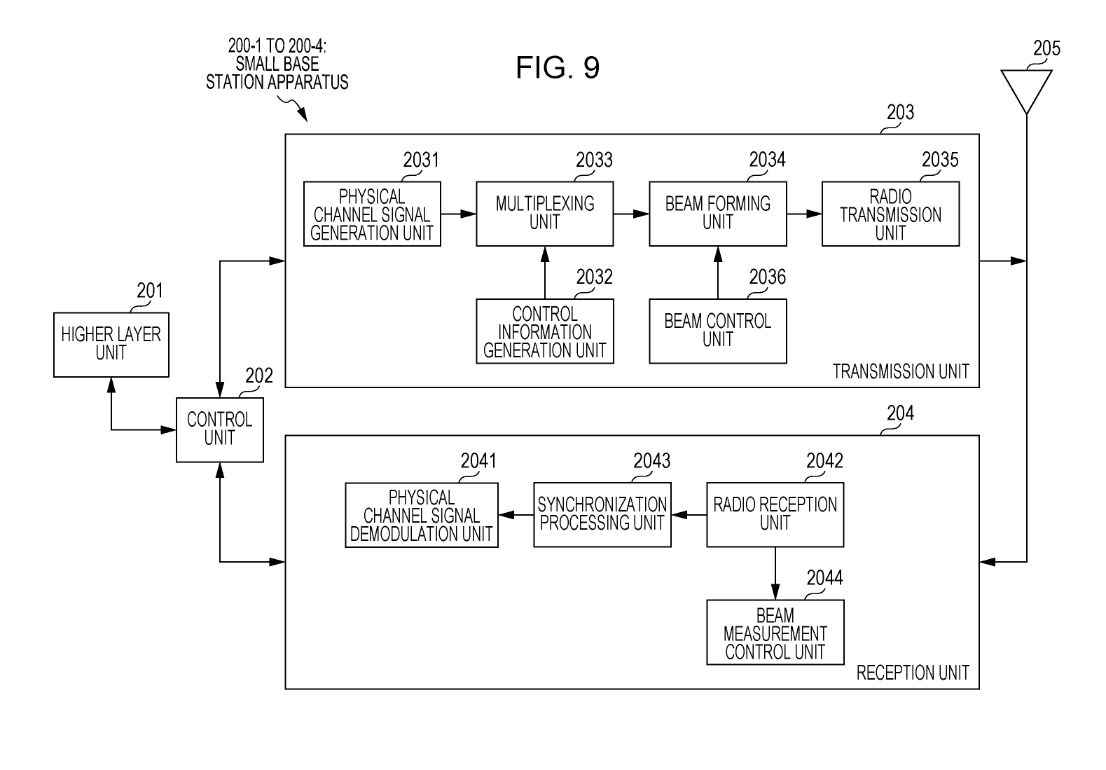

FIG. 9 is a block diagram illustrating one configuration example of the small base station apparatus 200 according to the present embodiment. This configuration is almost the same as the configuration illustrated in FIG. 6. The reception unit 204 further includes a synchronization processing unit 2043 and a beam measurement control unit 2044.

The beam control unit 2036 of each small base station apparatus 200 can control a BID on the basis of a signal that is transmitted by beamforming from another small base station apparatus 200 and acquired by the reception unit 204. For example, the reception unit 204 of the small base station apparatus 200 can receive a signal transmitted by beamforming from another small base station apparatus 200 toward the terminal device 300 and acquire reception quality for the signal, and the beam control unit 2036 can control a BID on the basis of the reception quality. In order for the small base station apparatus 200 to correctly receive the signal transmitted from another small base station apparatus 200, the synchronization processing unit 2043 included in the reception unit 204 can perform synchronization processing in the same manner as the synchronization processing unit 3042 included in the terminal device 300. That is, the reception unit 204 of the small base station apparatus 200 according to the present embodiment is configured to be capable of exhibiting a part of the function, of the reception unit 304 included in the terminal device 300, of receiving a signal transmitted by beamforming from the small base station apparatus 200.

The small base station apparatus 200 includes a plurality of antenna elements and thus can perform arrival angle estimation that estimates the direction from which a signal received by the small base station apparatus 200 arrives, or antenna array reception that receives only a signal arriving from only a specific direction. The beam measurement control unit 2044 of the small base station apparatus 200, by appropriately controlling the antenna 205, can perform antenna array reception that receives only a signal arriving from the direction of the angle of departure of a beam formable by a linear filter described in the codebook included in the small base station apparatus 200.

The signal that arrives from the direction of the angle of departure and is received by the antenna array reception is input into the beam measurement control unit 2044 through the radio reception unit 2042. The small base station apparatus 200 recognizes a reference signal that is correlated with a configurable BID. Accordingly, if the input signal is a reference signal that another small base station apparatus 200 transmits by beamforming to the terminal device 300 in order to measure beam quality, the beam measurement control unit 2044 can acquire the BID of a beam arriving from the direction of the angle of departure of the signal. The beam control unit 2036 can configure the BID of the small base station apparatus 200 on the basis of the BID information of another small base station apparatus 200 acquired by the beam measurement control unit 2044.

In a case where the beam control unit 2036 configures the BID of a beam having a certain angle of departure, a communication system in which beams having the same BID arrive in the same region can be realized as illustrated in FIG. 8 if the same BID as the BID acquired by antenna array reception with respect to the angle of departure is configured. For example, the higher layer unit 201 of the small base station apparatus 200 can recognize the frequency at which a BID is instructed to be used (BID histogram), by accumulating information that is included in the assistance information notified from the macro base station apparatus 100 and related to the BID used in massive MIMO transfer with respect to the terminal device 300. In a case where the BID is determined not to be frequently instructed to be used from the BID histogram accumulated by the higher layer unit 201, the beam control unit 2036 can determine that the number of terminal devices 300 in the direction of the angle of departure is not that large. Accordingly, the beam control unit 2036 can configure the same BID as the BID for a beam that has an angle of departure directed toward the region.

In a case where the beam control unit 2036 configures the BID of a beam having a certain angle of departure, a communication system in which beams having different BIDs arrive in the same region can be realized as illustrated in FIG. 7 if a different BID from the BID acquired by antenna array reception with respect to the angle of departure is configured. For example, in a case where the beam control unit 2036 determines from the BID histogram of the higher layer unit 201 that the BID is determined to be frequently instructed to be used, the beam control unit 2036 can determine that the number of terminal devices 300 in the direction of the angle of departure is significantly large. Accordingly, the beam control unit 2036 can configure a different BID from the BID for a beam that has an angle of departure directed toward the region.

While, in the description provided heretofore, the beam control unit 2036 can configure a BID on the basis of the frequency of BIDs included in the assistance information notified from the macro base station apparatus 100, apparently, a BID may be configured on the basis of the amount of traffic of the communication system. For example, the beam control unit 2036 can configure a BID in such a manner that a BID that is frequently instructed to be used in transmission of data destined for the terminal device 300 having a high traffic (or a large amount of data offloaded from the macro base station apparatus 100) is not instructed to be used in transmission of data destined for another terminal device 300.

Configuration of a BID in the beam control unit 2036 of each small base station apparatus 200 can be performed by the macro base station apparatus 100 that is in a state connected with each small base station apparatus 200. The higher layer unit 101 of the macro base station apparatus 100 can recognize in advance a table indicating a distribution and a temporal change of the amount of traffic of the cell in which the macro base station apparatus 100 is in, and can notify each governed small base station apparatus 200 of information related to configuration of a BID on the basis of the table. The macro base station apparatus 100, in the same manner as the small base station apparatus 200, may have a function of receiving a signal transmitted by beamforming from another small base station apparatus 200 and may determine configuration of a BID on the basis of the information.

In a case where the macro base station apparatus 100 controls configuration of a BID in the beam control unit 2036 of each small base station apparatus 200, the macro base station apparatus 100 can recognize a distribution of BIDs in a cell 100-1a. This indicates that the macro base station apparatus 100 can recognize BIDs that each terminal device 300 connected to the macro base station apparatus 100 can detect. Accordingly, the macro base station apparatus 100 can signal a set of BIDs for which reception quality is to be measured to each terminal device 300 on the basis of the distribution of BIDs in the cell 100-1a. For example, the macro base station apparatus 100 can acquire position information of each terminal device 300 in the cell 100-1a and can signal, to the terminal device 300, a BID that is assigned in great number in a region where the terminal device 300 exists. The terminal device 300 of each terminal device 300 preferably measures reception quality with respect to only a beam having the BID acquired from the signaling.

According to the macro base station apparatus 100, the small base station apparatus 200, and the terminal device 300 described heretofore, a communication system that highly efficiently performs massive MIMO transfer is realized by dynamically configuring a BID according to the constantly changing environment of the communication system, and thus the system throughput of the communication system can be improved.

### 4. Common Matters to All Embodiments

A program that operates in the macro base station apparatus, the small base station apparatus, and the terminal device according to the present invention is a program that controls a CPU and the like (a program that causes a computer to function) to realize the function of the above embodiments related to the present invention. Information that is handled by these devices is temporarily accumulated in a RAM when being processed and then is stored in various ROMs or HDDs, and the CPU reads, modifies, or writes the information if necessary. A recording medium storing the program may be any of a semiconductor medium (for example, a ROM or a non-volatile memory card), an optical recording medium (for example, a DVD, an MO, an MD, a CD, or a BD), a magnetic recording medium (for example, a magnetic tape or a flexible disk), and the like. The function of the above embodiments is not realized only by execution of the loaded program. The function of the present invention may be realized by processing of the program along with an operating system, another application program, or the like on the basis of instructions of the program.

In a case where the program is distributed in the market, the program can be distributed by being stored in a portable recording medium or can be transferred to a server computer that is connected through a network such as the Internet. In this case, the present invention includes a storage device of the server computer. A part or the entirety of the terminal device, the small base station apparatus, and the macro base station apparatus in the above embodiments may be typically realized by LSI that is an integrated circuit. Each functional block of the terminal device, the small base station apparatus, and the macro base station apparatus may be configured as individual chips, or a part or the entirety thereof may be integrated into a chip. In a case where each functional block is configured as integrated circuits, an integrated circuit control unit that controls the integrated circuits is added.

A technique for the circuit integration is not limited to LSI and may be realized by a dedicated circuit or a general-purpose processor. Alternatively, the circuit integration may be configured to be realized by both a dedicated circuit unit and software processing by configuring a part of the dedicated circuit with a general-purpose processor and realizing a part of each process or function by using the general-purpose processor. In a case where a circuit integration technology that replaces LSI emerges by advancement of semiconductor technology, an integrated circuit made by the technology can be used.

The present invention is not limited to the above embodiments. Application of the terminal device of the present invention is not limited to a mobile station device. Apparently, the terminal device can be applied to a stationary type or non-movable type electronic device installed indoors or outdoors, such as an AV device, a kitchen device, a cleaning or washing machine, an air-conditioning device, an office device, a vending machine, and other daily life devices.

While the embodiments of the invention are heretofore described in detail with reference to the drawings, specific configurations of the invention are not limited to the embodiments. Designs and the like that are made to the extent not departing from the gist of the invention are also included in the claims.

### INDUSTRIAL APPLICABILITY

The present invention is preferably used for a base station apparatus, a terminal device, and a communication method.

The present international application claims the benefit of priority based on Japanese Patent Application No. 2014-193247 filed on Sep. 24, 2014. The entire contents of Japanese Patent Application No. 2014-193247 are incorporated in the present international application.

### REFERENCE SIGNS LIST

100 MACRO BASE STATION APPARATUS
200, 200-1, 200-2, 200-3, 200-4 SMALL BASE STATION APPARATUS
300, 300-1, 300-2, 300-3 TERMINAL DEVICE
101, 201, 301 HIGHER LAYER UNIT
102, 202, 302 CONTROL UNIT
103, 203, 303 TRANSMISSION UNIT
104, 204, 304 RECEPTION UNIT
105, 205, 305 ANTENNA
1031, 2031, 3031 PHYSICAL CHANNEL SIGNAL GENERATION UNIT
1041, 2041, 3041 PHYSICAL CHANNEL SIGNAL DEMODULATION UNIT
1035, 2035, 3032 RADIO TRANSMISSION UNIT
1042, 2042, 3043 RADIO RECEPTION UNIT
2032 CONTROL INFORMATION GENERATION UNIT
2033 MULTIPLEXING UNIT
2034 BEAM FORMING UNIT
2043, 3042 SYNCHRONIZATION PROCESSING UNIT
2044 BEAM MEASUREMENT CONTROL UNIT

1. A second base station apparatus that includes a secondary cell and communicates with a first base station apparatus including a primary cell and with a terminal device,
wherein the same cell identification number as at least one of the other second base station apparatuses is configured,
a codebook that describes a plurality of types of information is included, and
the plurality of types of information is assigned different indexes.

2. The second base station apparatus according to claim 1,
wherein at least a part of assignment of the indexes is different from the other second base station apparatuses.

3. (canceled)

4. The second base station apparatus according to claim 1, comprising:
a reception unit that receives a signal transmitted from the other second base station apparatuses,
wherein the state of assignment of the indexes in the other second base station apparatuses is acquired on the basis of the signal transmitted from the other second base station apparatuses, and
assignment of the indexes in the second base station apparatus is determined on the basis of the state of assignment of the indexes in the other second base station apparatuses.

5. The second base station apparatus according to claim 1,
wherein assignment of the indexes is determined on the basis of information that is correlated with assignment of the indexes and signaled from the first base station apparatus.

6. The second base station apparatus according to claim 5,
wherein a synchronization signal that is correlated with the cell identification number is transmitted in the secondary cell after first precoding of the synchronization signal based on the codebook.

7. A first base station apparatus that includes a primary cell and communicates with a second base station apparatus including a secondary cell and with a terminal device,
wherein the second base station apparatus includes a codebook describing a plurality of types of information and is capable of assigning different indexes to the information,
the plurality of second base station apparatuses is separated into a plurality of groups,
a cell identification number of the second base station apparatus is determined on the basis of the separation, and
assignment of the indexes and information related to the cell identification number are signaled to the second base station apparatus.

8. The first base station apparatus according to claim 7,
wherein a cycle of transmission, by the second base station apparatus, of a synchronization signal correlated with the cell identification number in the secondary cell is signaled to the second base station apparatus.

9. (canceled)

10. A terminal device that communicates with a first base station apparatus including a primary cell and with a second base station apparatus including a secondary cell,
wherein a synchronization signal that is transmitted in the secondary cell is measured,
indexes that identify beamforming used in the synchronization signal are acquired, and
at least one of the indexes is transmitted in the primary cell to the first base station apparatus on the basis of reception quality for the synchronization signal.

11-12. (canceled)

13. The second base station apparatus according to claim 5,
wherein the synchronization signal is multiplexed and transmitted with another signal.
